(19) United States
(12) Patent Application Publication
(10) Pub. No.: US 2025/0089710 A1
(43) Pub. Date: Mar. 20, 2025

(54) CONCENTRATES AND PRESERVATIVE COMPOSITIONS PREPARED THEREFROM

(71) Applicant: PURAC BIOCHEM B.V., AC GORINCHEM (NL)

(72) Inventors: Esther LANSDAAL, AC GORINCHEM (NL); Remco Johannes Antonius STEVENS, AC GORINCHEM (NL)

(21) Appl. No.: 18/720,233

(22) PCT Filed: Dec. 14, 2022
(86) PCT No.: PCT/EP2022/085978

§ 371 Date: Jun. 14, 2024

(30) Foreign Application Priority Data
Dec. 15, 2021 (EP) 21214872.0

(51) Int. Cl. A01N 37/36; A01N 31/08; A01N 37/06; A01N 37/10; A01P 1/00; A01P 3/00; A01P 13/00

(52) U.S. Cl. CPC A01N 37/36; A01N 31/08; A01N 37/06; A01N 37/10; A01P 1/00; A01P 3/00; A01P 13/00

(57) ABSTRACT

The invention pertains to a concentrate comprising: at least 45 wt. % of lactic acid; from 0.01 to 50 wt. % of benzyl alcohol; from 0.01 to 4.0 wt. % of at least one sorbate salt selected from the group consisting of potassium sorbate and sodium sorbate and/or from 0.01 to 20 wt. % of at least one benzoate salt selected from the group consisting of sodium benzoate and potassium benzoate; and at most 20 wt. % of a solvent. The invention also pertains to a composition comprising the concentrate, a method of manufacturing the concentrate, a method of manufacturing the composition, a method of cleaning an object (using the composition), and uses of the concentrate and the composition.

### TECHNICAL FIELD OF THE INVENTION

The present invention relates to a concentrate, a composition having antimicrobial activity, a method of manufacturing the concentrate, a method of manufacturing the composition, a method of cleaning an object (using the composition), a use of the concentrate in a method for preserving products, and a use of the composition in a non-therapeutic method for reducing a bacterial, fungal, and/or algae population.

### BACKGROUND AND SUMMARY OF THE INVENTION

Preservatives compositions are added to various products to prevent decomposition by microbial growth and/or by undesirable chemical changes. The antimicrobial compounds present in a preservative composition determine against which microbial species the preservative composition has antimicrobial activity.

Due to regulatory requirements, only few antimicrobial compounds can be used in preservative compositions. The antimicrobial compounds that are approved for use in preservative compositions generally do not possess antimicrobial activity against all microbial species. Therefore, approved antimicrobial compounds are commonly used in combination. However, even in combination, it is difficult to achieve significant antimicrobial activity against a broad spectrum of microorganisms, including, without limitation, bacteria, fungi, and algae. This is shown in e.g. US 2012/0201902, which describes that various preservatives comprising combinations of benzyl alcohol, lactic acid, and aliphatic diols had no significant activity against Aspergillus niger (now known as A. brasiliensis).

Even if a preservative composition does have broad antimicrobial activity, that antimicrobial activity is generally pH-dependent. Indeed, as described in US 2020/0305426, many conventional preservative compositions exhibit little to no antimicrobial activity in products having a pH in the range of from pH 5 to pH 9. This significantly limits the potential applications of conventional preservative compositions, as e.g. many personal care products have a pH in this range. An additional downside of the compositions described in US 2020/0305426 is that these compositions may unstable against recontamination, meaning that, as a product comprising these compositions is used, microorganisms may eventually start to grow in the product.

There is, thus, a need in the art for compositions that demonstrate antimicrobial activity against a broad spectrum of microorganisms even at (near-)neutral pH (e.g., in the range of from pH 5 to pH 9). It is an object of the invention to provide such compositions.

Therefore, in an aspect, the invention relates to a composition comprising: from 0.3 to 1.0 wt. % of lactic acid or a salt thereof; from 0.1 to 1.0 wt. % of benzyl alcohol; from 0.01 to 0.2 wt. % of at least one sorbate salt selected from the group consisting of potassium sorbate and sodium sorbate and/or from 0.01 to 0.2 wt. % of at least one benzoate salt selected from the group consisting of sodium benzoate and potassium benzoate; and at least 40 wt. % of water, wherein the composition has a pH of from 2.0 to 8.0. It was found this composition, surprisingly, has significant antimicrobial activity against bacteria and fungi at a pH in the range of from pH 5 to pH 8. As shown in the Examples, the antimicrobial activity at near-neutral pH could only be achieved when the lactic acid (or salt thereof), the benzoate or sorbate salt, and the benzyl alcohol were present in combination. As a result of their antimicrobial activity at (near-)neutral and even slightly alkaline pH, the compositions according to the invention can be used in many applications, such as food products, personal care products, and cleaning products having a (near-)neutral or slightly alkaline pH.

In another aspect, the invention relates to a concentrate comprising: at least 45 wt. % of lactic acid; from 0.01 to 50 wt. % of benzyl alcohol; from 0.01 to 4.0 wt. % of at least one sorbate salt selected from the group consisting of potassium sorbate and sodium sorbate and/or from 0.01 to 20 wt. % of at least one benzoate salt selected from the group consisting of sodium benzoate and potassium benzoate; and at most 20 wt. % of a solvent. This concentrate is a key aspect of the invention. Not only can it be diluted to form the composition according of the invention, it is also surprisingly stable at low temperatures. Stability of concentrates at low temperatures is desired, because temperatures during transport and storage may vary and the concentrate should be stable even in cold climates (e.g., in Alaska).

In another aspect, the invention relates to a composition comprising from 0.1 to 5.0 wt. % of the concentrate according to the invention and at least 40 wt. % of water, wherein the composition has a pH of from 2.0 to 8.0. The advantages associated with this composition are the same as those defined above in relation to the composition according to the invention. It has also been found that products comprising the composition according to the invention are surprisingly stable against recontamination with bacteria and fungi.

In another aspect, the invention relates to a method of manufacturing the concentrate according to the invention, wherein the method comprises the steps of: combining lactic acid, benzyl alcohol, and at least one sorbate salt selected from the group consisting of potassium sorbate and sodium sorbate and/or at least one benzoate salt selected from the group consisting of sodium benzoate and potassium benzoate to form a mixture; and heating the mixture to a temperature of from 65 to 95° C. for at least 30 minutes.

In another aspect, the invention relates to a method of manufacturing the composition according to the invention, wherein the method comprises the steps of: providing a concentrate according to the invention; and diluting the concentrate with water. The step of diluting the concentrate may be performed in two or more stages.

In another aspect, the invention relates to a method of cleaning an object, wherein the method comprises the step of providing a (cleaning) composition according to the invention to an object, optionally using a wipe or a spray.

In another aspect, the invention relates to a use of the concentrate according to the invention in a method for preserving a product selected from the group consisting of agrochemical products, cleaning products (in particular, detergents, (dish)washing liquids, industrial cleaning compositions, soaps), metal (working) fluids, medicinal products (in particular, home care products), paints, descaling compositions, or cosmetics.

In another aspect, the invention relates to a use of the composition according to the invention in a non-therapeutic method for reducing a bacterial population, an algae population, and/or a fungal population, preferably a bacterial population or a fungal population.

### DETAILED DESCRIPTION

The aspects of the invention will be discussed in more detail below. Specific advantages of the compositions according to the invention, the concentrate according to the invention, the methods according to the invention, and the uses according to the invention, as well as of specific embodiments thereof, will become apparent from the further specification.

### The Concentrate

As mentioned above, disclosed herein is a concentrate comprising: at least 45 wt. % of lactic acid; from 0.01 to 50 wt. % of benzyl alcohol; from 0.01 to 4.0 wt. % of at least one sorbate salt selected from the group consisting of potassium sorbate and sodium sorbate and/or from 0.01 to 20 wt. % of at least one benzoate salt selected from the group consisting of sodium benzoate and potassium benzoate; and at most 20 wt. % of a solvent.

The concentrate comprises at least 45 wt. % of lactic acid (based on the total weight of the concentrate). After dilution of the concentrate, for instance when added to a product to be preserved, or a cleaning liquid, the composition comprising the lactic acid according to the invention provides significant antimicrobial activity against bacteria (Gram-positive and Gram-negative bacteria) and yeasts. It may be preferable for the concentrate to comprise 47 wt. % of lactic acid. The amount of lactic acid in the concentrate may be as high as 90 wt. %. It is, however, preferable for the amount of lactic acid in the concentrate to be at most 85 wt. %, more preferably at most 70 wt. %, even more preferably at most 60 wt. %, still more preferably at most 55 wt. %. A typical dilution would be with water or an aqueous matrix comprising at least 40 wt. % of water, the dilution containing from 0.1 to 5.0 wt. % of the concentrate according to the invention.

The concentrate comprises from 0.01 to 50 wt. % of benzyl alcohol (based on the total weight of the concentrate). After dilution of the concentrate, the composition comprising benzyl alcohol according to the invention provides significant antimicrobial activity against bacteria. The concentrate preferably comprises benzyl alcohol in an amount of at least 1 wt. %, more preferably at least 5 wt. %, even more preferably at least 10 wt. %, still more preferably at least 20 wt. %, still more preferably at least 30 wt. %, still more preferably at least 40 wt. %. The concentrate preferably comprises benzyl alcohol in an amount of at most 49 wt. %, more preferably in an amount of at most 48 wt. %.

The concentrate may comprise potassium and/or sodium sorbate in a total amount of 0.01-4.0 wt. % (based on the total weight of the concentrate). After dilution of the concentrate, the the composition comprising sorbate salt according to the invention provides significant antimicrobial activity against fungi and yeasts (and some antimicrobial activity against bacteria). The concentrate preferably comprises the sorbate salt in a total amount of at least 0.1 wt. %, more preferably at least 0.5 wt. %, more preferably at least 1.0 wt. %, more preferably at least 1.5 wt. %. The concentrate preferably comprises the sorbate salt in a total amount of at most 3.5 wt. %, more preferably at most 3.0 wt. %. The sorbate salt is preferably potassium sorbate.

The concentrate may comprise sodium and/or potassium benzoate in a total amount of 0.01-20 wt. % (based on the total weight of the concentrate). After dilution of the concentrate, the composition comprising benzoate salts according to the invention with antimicrobial activity against fungi and yeasts, as well as antimicrobial activity against bacteria. The concentrate preferably comprises the benzoate salt in a total amount of at least 1.0 wt. %, more preferably at least 2.0 wt. %, more preferably at least 3.0 wt. %. The concentrate preferably comprises the benzoate salt in a total amount of at most 18 wt. %. The concentrate more preferably comprises the benzoate salt in a total amount of at most 15 wt. %, more preferably at most 10 wt. %, even more preferably at most 7.0 wt. %, still more preferably at most 5 wt. %. The benzoate salt is preferably sodium benzoate.

The surprising stability of the concentrate at low temperatures can be increased by controlling the weight ratios in which the lactic acid (or salt thereof), the benzyl alcohol, and the sorbate and/or benzoate salt are present in the concentrate. The weight ratio of lactic acid to benzyl alcohol in the concentrate may be in the range of from 0.5:1 to 5:1, preferably from 0.8:1 to 3:1, more preferably from 0.9:1 to 1.5:1, even more preferably about 1:1. The weight ratio of lactic acid to benzoate salt in the concentrate may be in the range from 5:1 to 20:1, preferably from 8:1 to 15:1, more preferably from 9:1 to 11:1, even more preferably about 10:1. The weight ratio of benzyl alcohol to benzoate salt in the concentrate may be in the range of from 2:1 to 20:1, preferably from 5:1 to 15:1, more preferably from 8:1 to 12:1, even more preferably from 9:1 to 11:1, still more preferably about 10:1.

Combinations of these weight ratios are particularly preferred. For example, the weight ratio of lactic acid to benzyl alcohol in the concentrate may be in the range of from 0.5:1 to 5:1 and the weight ratio of benzyl alcohol to benzoate salt may be in the range of from 2:1 to 20:1. As another example, the weight ratio of lactic acid to benzyl alcohol in the concentrate may be in the range of from 0.5:1 to 5:1 and the weight ratio of lactic acid to benzoate salt may be in the range from 5:1 to 20:1. As another example, the weight ratio of lactic acid to benzoate salt may be in the range from 5:1 to 20:1 and the weight ratio of benzyl alcohol to benzoate salt may be in the range of from 2:1 to 20:1. As yet another example, the weight ratio of lactic acid to benzyl alcohol in the concentrate may be in the range of from 0.5:1 to 5:1, the weight ratio of lactic acid to benzoate salt may be in the range from 5:1 to 20:1, and the weight ratio of benzyl alcohol to benzoate salt may be in the range of from 2:1 to 20:1. Of course, combinations of ranges may also be made using the preferred ranges defined above (e.g., in the previous paragraph).

Also in embodiments wherein the concentrate comprises at least one sorbate salt, the weight ratio of lactic acid to benzyl alcohol in the concentrate may be in the range of from 0.5:1 to 5:1, preferably from 0.8:1 to 3:1, more preferably from 0.9:1 to less than 1.1:1. The weight ratio of lactic acid to sorbate salt in the concentrate may be in the range from 11:1 to 25:1, preferably from 17:1 to 23:1, more preferably from 19:1 to 21:1, still more preferably about 20:1. The weight ratio of benzyl alcohol to sorbate salt may be in the range of from 10:1 to 25:1, preferably from 15:1 to 23:1, more preferably from 17:1 to 22:1, even more preferably from 18:1 to 20:1, still more preferably about 19:1.

Combinations of these weight ratios are particularly preferred. In particular, the weight ratio of lactic acid to benzyl alcohol in the concentrate may be in the range of from 0.5:1 to 5:1 and the weight ratio of benzyl alcohol to sorbate salt may be in the range of from 10:1 to 25:1. As another example, the weight ratio of lactic acid to benzyl alcohol in the concentrate may be in the range of from 0.5:1 to 5:1 and the weight ratio of lactic acid to sorbate salt may be in the range from 11:1 to 25:1. As another example, the weight ratio of lactic acid to sorbate salt in the concentrate may be in the range from 11:1 to 25:1 and the weight ratio of benzyl alcohol to sorbate salt may be in the range of from 10:1 to 25:1. As yet another example, the weight ratio of lactic acid to benzyl alcohol in the concentrate may be in the range of from 0.5:1 to 5:1, the weight ratio of lactic acid to sorbate salt may be in the range from 11:1 to 25:1, and the weight ratio of benzyl alcohol to sorbate salt may be in the range of from 10:1 to 25:1. Of course, combinations of ranges may also be made using the preferred ranges defined above (e.g., in the previous paragraph).

The concentrate comprises at most 20 wt. % of a solvent (based on the total weight of the concentrate), preferably less than preferably at most 10 wt. %, more preferably at most 5.0 wt. %, more preferably at most 3.0 wt. %, even more preferably less than 2.0 wt. %. As a lower limit, a value of 0.01 wt. % solvent may be mentioned. It is particularly preferred that the concentrate comprises at most 20 wt. % of water (or any of the other preferred ranges mentioned for the solvent). It will be evident that the solvent can be any liquid in which lactic acid, the sorbate salt and/or the benzoate salt, and the benzyl alcohol can dissolve at room temperature. Suitable solvents include water, ethanol, monopropylene glycol (MPG), polyethylene glycol (PEG), glycerol, glycerine, and mixtures thereof.

The concentrate may comprise 10 wt. % or less (based on the total weight of the concentrate), of (antimicrobial) compounds other than lactic acid, the benzyl alcohol, the benzoate salt (if present), and the sorbate salt (if present). The concentrate preferably comprises at most 8 wt. % of other compounds, more preferably at most 5 wt. %, even more preferably at most 3 wt. % of other compounds. In particular, the concentrate may comprise less than 10 wt. % of C₁₋₈ carboxylic acids and C₁₋₈ carboxylate salts other than lactic acid, the sorbate salt, and the benzoate salt, preferably less than 5.0 wt. %, more preferably less than 3.0 wt. %, even more preferably less than 2.0 wt. %., still more preferably less than 1.0 wt. %. The C₁₋₈ carboxylic acid (and C₁₋₈ carboxylate salts) may be selected from the group consisting of acetic acid, propionic acid, tartaric acid, and salts thereof. Other compounds are not strictly necessary for antimicrobial activity and so do not need to be present in the concentrate. Consequently, leaving these other compounds out of the concentrate has economical and environmental advantages.

The concentrate may comprise less than 5.0 wt. % of a trihydroxy compound (based on the total weight of the concentrate), preferably less than 3.0 wt. %, more preferably less than 1.0 wt. % of a trihydroxy compound. The trihydroxy compound may be a C₁₋₈ aliphatic trihydroxy compound, such glycerol. Additionally or alternatively, the concentrate may comprise less than 5.0 wt. % of a dihydroxy compound (based on the total weight of the concentrate), preferably less than 3.0 wt. %, more preferably less than 1.0 wt. % of a dihydroxy compound. The dihydroxy compound may be a C₁₋₈ aliphatic dihydroxy compound, such as a C₁₋₈ aliphatic dihydroxy compound selected from the group consisting of ethylene glycol, propylene glycol, butylene glycol, pentylene glycol, and hexylene glycol. The absence of such di- and trihydroxy compounds is preferred, as they may negatively affect stability of the concentrate.

As mentioned earlier, the concentrate is surprisingly stable even at low temperatures, thanks at least in part due to the specific combination of lactic acid, benzyl alcohol, and the benzoate salt and/or the sorbate salt. The stability of the concentrate can be determined by storing a 50 mL sample of the concentrate in a standard cooler at 4° C., preferably at −25° C., for 28 days. The sample is then removed from the freezer and the turbidity of the sample immediately analyzed. Stability was determined by visual inspection. Samples wherein precipitation, discoloration, and/or turbidity are visible with the naked eye after the samples have been brought back to room temperature (21° C.) are marked as unstable samples. Stable samples are clear, monophasic solutions (of lactic acid, benzyl alcohol, and the benzoate salt and/or the sorbate salt) after the sample has been brought back to room temperature (21° C.), even if they showed e.g. precipitation when taken from the cooler.

### Method for Manufacturing the Concentrate

In another aspect, the invention provides a method for manufacturing the concentrate according to the invention, comprising the steps of: combining lactic acid, benzyl alcohol, and at least one sorbate salt selected from the group consisting of potassium sorbate and sodium sorbate and/or at least one benzoate salt selected from the group consisting of sodium benzoate and potassium benzoate to form a mixture; and heating the mixture to a temperature of from 65 to 95° C. for at least 30 minutes.

The step of combining the lactic acid, the benzyl alcohol, and the at least one benzoate and/or the at least one sorbate salt is, of course, such that a concentrate with the weight percentages as defined above is obtained. In preferred embodiments, the lactic acid and the benzyl alcohol are first combined, and the benzoate salt and/or the sorbate salt is added subsequently.

The mixture is heated to a temperature of from 65 to 95° C. The mixture is preferably heated to a temperature of from 70 to 90° C., more preferably of from 75 to 85° C. The heating is preferably performed under stirring of the mixture. The heating is generally applied for a period of at least 30 minutes. The heating may be applied for a period of at least 1 hour, more preferably at period of at least 1.5 hours, even more preferably at least 2 hours. The heating is preferably applied for not longer than 24 hours. Applying the heating regimen according to the method of manufacturing the concentrate unexpectedly contributes to the stability of the concentrate, especially at low temperatures. Moreover, the heating regimen helps to obtain a clear, transparent, homogenous solution. There are, thus, significant commercial benefits associated with performing the heating regimen as defined above.

Also provided herein is a concentrate obtainable by the method according of manufacturing the concentrate according to the invention. It will be evident that any preferences defined above in relation to the concentrate equally apply the concentrate obtainable by the method of manufacturing the concentrate according to the invention.

### Compositions

Also provided herein is a composition comprising the concentrate according to the invention. Specifically, provided is a composition comprising from 0.1 to 5.0 wt. % of the concentrate according to the invention and at least 40 wt. % of water (based on the total weight of the composition), wherein the composition has a pH of 2.0 to 8.0. The composition preferably comprises from 0.5 to 4.5 wt. % of the concentrate, more preferably from 1.0 to 4.0 wt. % of the concentrate, even more preferably from 1.5 to 3.5 wt. % of the concentrate.

Another composition provided herein is a composition comprising: from 0.3 to 1.0 wt. % of lactic acid or a salt thereof; from 0.1 to 1.0 wt. % of benzyl alcohol; from 0.01 to 0.2 wt. % of at least one sorbate salt selected from the group consisting of potassium sorbate and sodium sorbate and/or from 0.01 to 0.2 wt. % of at least one benzoate salt selected from the group consisting of sodium benzoate and potassium benzoate; and at least 40 wt. % of water, wherein the composition has a pH of from 2.0 to 8.0.

The compositions provided herein require at least three active ingredients (lactic acid, benzyl alcohol, and the benzoate salt and/or the sorbate salt). It has surprisingly been found that the specific combination of (just) these three or four active ingredients, optionally in the presence of one or more surfactants, results in an antimicrobial effect against fungi and bacteria, even at concentrations in the pH range of from pH 5.5 to pH 8.0. In conventional preservative compositions, other components are (also) included in order to achieve antimicrobial activity in this pH range. This is because it was thought that lactic acid, benzyl alcohol, benzoate salts and/or sorbate salts (alone or in combination) would not be effective at a relatively high pH (e.g., pH 7 or above).

The compositions provided herein comprise at least 40 wt. % of water (based on the total weight of the composition). In preferred embodiments, the compositions comprise at least 50 wt. % of water, preferably at least 60 wt. % of water, more preferably at least 70 wt. % of water, even more preferably at least 80 wt. % of water, still more preferably at least 90 wt. % of water. As an upper limit, the compositions may, for example, comprise at most 99 wt. % of water, preferably at most 97 wt. % of water, more preferably at most 93 wt. % of water. Impressively, it has been demonstrated that even if the water content is 98.5 wt. %, antimicrobial activity of the compositions according to the invention is preserved.

The compositions provided herein may have a pH of from 3.0 to 8.0, in particular from 4.0 to 8.0, more in particular 5.0 to 8.0, more in particular from 5.5 to 8.0, more in particular from 5.5 to 7.5, more in particular from 5.5 to 7.0. The higher the pH at which the compositions still show antimicrobial activity, the more suitable they are for e.g. cleaning and homecare products, which commonly have a pH in the range of from pH 5 to pH 9.

The compositions provided herein preferably comprise from 0.4 to 0.8 wt. % of lactic acid or a salt thereof (based on the total weight of the composition), more preferably 0.5 to 0.7 wt. %, even more preferably from 0.5 to 0.6 wt. %. The compositions provided herein may comprise from 0.3 to 1.0 wt. % of benzyl alcohol (based on the total weight of the composition). The compositions provided herein preferably comprise from 0.3 to 0.9 wt. % of benzyl alcohol (based on the total weight of the composition), more preferably from 0.4 to 0.8 wt. %. The compositions provided herein preferably comprise from 0.01 to 0.1 wt. % of at least one sorbate salt selected from the group consisting potassium and sodium sorbate (based on the total weight of the composition), more preferably from 0.02 to 0.05 wt. %. Such low concentrations of the sorbate salt are associated with decreased discoloration of the compositions over time. The sorbate salt is preferably potassium sorbate. The compositions provided herein preferably comprise from 0.02 to less than 0.2 wt. % of at least one benzoate salt. More preferably, the compositions comprise from 0.02 to 0.15 wt. % of at least one benzoate salt selected from the group consisting of sodium and potassium benzoate, even more preferably 0.03 wt. % to 0.12 wt. %. Such low concentrations of the benzoate salt are associated with decreased discoloration of the compositions over time. The benzoate salt is preferably sodium benzoate.

In a particularly preferred embodiment, the compositions comprise from 0.4 to 0.8 wt. % of lactic acid or a salt thereof, from 0.3 to 0.9 wt. % of benzyl alcohol, and from 0.01 to 0.1 wt. % of the at least one sorbate salt (based on the total weight of the composition), optionally wherein the pH of the composition is in the range of from pH 5.5 to pH 8.0. In another particularly preferred embodiment, the compositions comprise from 0.4 to 0.8 wt. % of lactic acid or a salt thereof, from 0.3 to 0.9 wt. % of benzyl alcohol, and from 0.02 to 0.15 wt. % of the at least one benzoate salt (based on the total weight of the composition), optionally wherein the pH of the composition is in the range of from pH 5.5 to pH 8.0.

In a more preferred embodiment, the compositions comprise from 0.5 to 0.7 wt. % of lactic acid or a salt thereof, from 0.4 to 0.8 wt. % of benzyl alcohol, and from 0.02 to 0.05 wt. % of the at least one sorbate salt (based on the total weight of the composition), optionally wherein the pH of the composition is in the range of from pH 5.5 to pH 8.0. In another more preferred embodiment, the compositions comprise from 0.5 to 0.7 wt. % of lactic acid or a salt thereof, from 0.4 to 0.8 wt. % of benzyl alcohol, and from 0.03 to 0.12 wt. % of the at least one benzoate salt (based on the total weight of the composition), optionally wherein the pH of the composition is in the range of from pH 5.5 to pH 8.0.

The compositions provided herein may contain the lactic acid, the benzyl alcohol, and the sorbate salt and/or the benzoate salt in a specific weight ratio. These specific weight ratios result in improved antimicrobial activity at elevated pH (e.g., at a pH in the range of from pH 5.5 to pH 8.0). In preferred embodiments, the composition has a weight ratio of lactic acid to the benzyl alcohol in the range of from 0.5:1 to 5:1 (preferably from 0.8:1 to 3:1, more preferably from 0.9:1 to 1.5:1, even more preferably about 1:1), a weight ratio of lactic acid to the benzoate salt in the range from 5:1 to 20:1 (preferably from 8:1 to 15:1, more preferably from 9:1 to 11:1, even more preferably about 10:1), a weight ratio of benzyl alcohol to the benzoate salt in the range of from 2:1 to 20:1 (preferably from 5:1 to 15:1, more preferably from 8:1 to 12:1, more preferably from 9:1 to 11:1, still more preferably about 10:1), and/or a pH of from 3.0 to 8.0 (in particular from 4.0 to 8.0, more in particular from 5.0 to 8.0, more in particular from 5.5 to 8.0, more in particular from 5.5 to 7.5, more in particular from 5.5 to 7.0). In other preferred embodiments, the composition has a weight ratio of lactic acid to the benzyl alcohol in the range of from 0.5:1 to 5:1 (preferably from 0.8:1 to 3:1, more preferably from 0.9:1 to less than 1.1:1), a weight ratio of lactic acid to the sorbate salt in the range from 11:1 to 25:1 (preferably from 17:1 to 23:1, more preferably from 19:1 to 21:1, still more preferably about 20:1), a weight ratio of benzyl alcohol to the sorbate salt in the range of from 10:1 to 25:1 (preferably from 15:1 to 23:1, more preferably from 17:1 to 22:1, even more preferably from 18:1 to 20:1, still more preferably about 19:1), and/or a pH of from 3.0 to 8.0 (in particular from 4.0 to 8.0, more in particular from 5.0 to 8.0, more in particular from 5.5 to 8.0, more in particular from 5.5 to 7.5, more in particular from 5.5 to 7.0).

These compositions are capable of achieving a log reduction in the number of viable fungi of at least 2 (as compared to the value obtained for the inoculum) after contacting for 7 days, as measured according to the Pharmacopeia 5.1.3 challenge test, wherein the fungi are a mixture of Candida albicans (e.g., ATCC 10231) and Aspergillus brasiliensis (e.g., ATCC 16414). The Pharmacopeia 5.1.3 challenge test is described in the European Pharmacopoeia 7.0, starting at pg. 505. The log reduction in the number of viable fungi (as compared to the value obtained for the inoculum) is preferably at least 3, more preferably at least 4.0. The pH of the inoculated containers, during the measurement, is set at a predetermined value. For example, to measure the activity of the composition at pH 6.5, the pH of the inoculated containers should be set at pH 6.5 for the duration of the measurement.

Furthermore, these compositions are capable of achieving a log reduction in the number of viable bacteria of at least 3 (as compared to the value obtained for the inoculum) after containing for 7 days, as measured according to the Pharmacopeia 5.1.3 challenge test, wherein the bacteria are a mixture of Pseudomonas aeruginosa (e.g., ATCC 15442), Staphylococcus aureus (e.g., ATCC 6538), and Escherichia coli (ATCC 10536) The Pharmacopeia 5.1.3 challenge test is described in the European Pharmacopoeia 7.0, starting at pg. 505. The log reduction in the number of viable fungi (as compared to the value obtained for the inoculum) of at least 3 is preferably achieved after contacting for 48 hours, more preferably after contacting for 24 hours. The pH of the inoculated containers, during the measurement, is set at a predetermined value. For example, to measure the activity of the composition at pH 6.5, the pH of the inoculated containers should be set at pH 6.5 for the duration of the measurement.

The composition may comprise less than 5.0 wt. % of a trihydroxy compound (based on the total weight of the composition), preferably less than 3.0 wt. %, more preferably less than 1.0 wt. %, even more preferably less than 0.5 wt. %, of a trihydroxy compound. The trihydroxy compound may be a C₁₋₈ aliphatic trihydroxy compound, such glycerol. Additionally or alternatively, the composition may comprise less than 5.0 wt. % of a dihydroxy compound (based on the total weight of the composition), preferably less than 3.0 wt. %, more preferably less than 1.0 wt. %, even more preferably less than 0.5 wt. %, of a dihydroxy compound. The dihydroxy compound may be a C₁₋₈ aliphatic dihydroxy compound, such as a C₁₋₈ aliphatic dihydroxy compound selected from the group consisting of ethylene glycol, propylene glycol, butylene glycol, pentylene glycol, and hexylene glycol. The absence of such di- and trihydroxy compounds is preferred, as they may negatively affect stability of the composition.

It may be preferable to add certain additives to the composition according to the invention in order to increase the antimicrobial activity of the composition further. Surfactants are preferably added to the composition for this reason. The composition may comprise from 0.1 to 15 wt. % of surfactant (based on the total weight of the composition), preferably from 1 to 10 wt. %, more preferably from 3 to 8 wt. %. The composition preferably contains at least two surfactants, optionally at least two anionic surfactants, at least one anionic surfactant and at least one non-ionic surfactant, or at least one cationic surfactant and at least one non-ionic surfactant.

The composition preferably comprises one or more surfactants selected from the group consisting of C₆₋₁₄ alkyl ether sulphates, C₆₋₁₄ ether alkyl sulfonates, C₆₋₁₄ alkyl ether phosphates, C₆₋₁₄ alkyl ether carboxylates, C₆₋₁₄ alkyl sulphates, C₆₋₁₄ alkyl sulfonates, C₆₋₁₄ alkyl phosphates, and C₆₋₁₄ alkyl carboxylates, preferably one or more C₆₋₁₄ alkyl ether sulphates. The total amount of C₆₋₁₄ alkyl ether sulphates in the composition is preferably from 0.1 to 5.0 wt. % (based on the total weight of the composition), more preferably from 1.0 to 4.5 wt. %.

Additionally, the composition preferably comprises one or more alkyl polyglucoside surfactants. The amount of alkyl polyglucoside surfactant is preferably in the range of 1.0 to 5.0 wt. % (based on the total weight of the composition), more preferably in the range of from 1.0 to 3.0 wt. %. An alkyl polyglucoside surfactant is a compound according to the general formula (G)ₙ-O—R′, wherein G is a reducing saccharide moiety containing 5 or 6 carbon atoms, R′ is a straight chain or branched alkyl or alkylene group having 6 to 20 carbon atoms, and n is the number of monosaccharide repeat units in the polyglucoside. R′ is preferably a straight chain alkyl or alkylene group having 6 to 20 carbon atoms. The number of monosaccharide repeat units (n) is preferably is in the range of 1 to 8.

In particularly preferred embodiments, the composition further comprises from 0.1 to 5.0 wt. % of C₆₋₁₄ alkyl ether sulphate surfactant, more preferably from 1.0 to 4.5 wt. %, and from 1.0 to 5.0 wt. % of alkyl polyglucoside surfactant, more preferably in the range of from 1.0 to 3.0 wt. %.

The composition may also comprise one or more chelating agents, which help protect the composition against oxidative degradation. For example, the composition may comprise one or more chelating agents selected from the group consisting of ethylenediaminetetraacetic acid (EDTA), glutamic acid N,N-diacetic acid (GLDA), methylglycine diacetic acid (MGDA), gluconic acid, glutamic acid, citric acid, and salts thereof.

In some embodiments, the composition is a cleaning composition, preferably a (dish)washing composition.

### Method of Manufacturing the Compositions

Also provided herein is a method of manufacturing the compositions according to the invention, comprising the steps of providing a concentrate according to the invention and diluting the concentrate with water. The resulting composition is a composition as defined above.

The method comprises diluting the composition according to the invention with an aqueous solution or aqueous dispersion, preferably water. The aqueous solution or dispersion used to dilute the composition may comprise, in addition to water, one or more other components. For example, the aqueous solution or dispersion may comprise protective agents, such as EDTA and GLDA.

In the method, the composition according to the invention may be diluted such that the resulting preservative composition comprises 0.1 to 5.0 wt. % of the concentrate according to the invention, preferably from 0.5 to 3.0 wt. % of the concentrate, more preferably from 1.0 to 2.0 wt. % of the concentrate.

Also provided herein is a composition obtainable by the method according of manufacturing the compositions according to the invention. It will be evident that any preferences defined above in relation to the composition equally apply the composition obtainable by the method of manufacturing the composition according to the invention.

### Uses

Also provided herein is a use of the concentrate according to the invention in a method for preserving a product selected from the group consisting of agrochemical products, cleaning products (in particular, detergents, (dish)washing liquids, industrial cleaning compositions, soaps), metal (working) fluids, medicinal products (in particular, home care products), paints, descaling compositions, or cosmetics. The product may have a pH in the range of pH 5.5 to 8.0.

Also provided herein is a use of the composition according to the invention in a non-therapeutic method for reducing a bacterial population, an algae population, and/or a fungal population, preferably a bacterial population or a fungal population. The bacterial population may be a gram-positive, such as S. aureus, or gram-negative bacterial population, such as E. coli and P. aeruginosa. The fungal population may be a C. albicans and A. brasiliensis population.

Also provided herein is a method of cleaning an object, wherein the method comprises the step of providing a (cleaning) composition according to the invention to an object, optionally using a wipe or a spray.

When amounts, concentrations, dimensions and other parameters are expressed in the form of a range, a preferable range, an upper limit value, a lower limit value or preferable upper and lower limit values, it should be understood that any ranges obtainable by combining any upper limit or preferable value with any lower limit or preferable value are also specifically disclosed, irrespective of whether the obtained ranges are clearly mentioned in the context. In addition, it should be understood that all percentages mentioned herein are weight percentages (calculated on the total weight of the composition), unless specified otherwise.

All documents mentioned herein are incorporated by reference in their entirety or, alternatively, to provide the disclosure for which there were specifically relied upon.

### EXAMPLES

The following examples will illustrate the practice of the invention in some preferred embodiments and are not intended to be limiting. Other embodiments within the scope of the invention will be apparent to the skilled person.

### Example 1: Preparation of Concentrates

Benzyl alcohol was added to lactic acid (PURAC® HS100), after which sodium benzoate or potassium sorbate was added to form a mixture having the weight ratios as defined in Table 1a. The mixture comprising lactic acid, benzyl alcohol, and sodium benzoate or potassium sorbate was stirred at 80° C. for 2 hours. The concentrate was then allowed to cool to room temperature. The following, clear and homogenous concentrates were obtained:

TABLE 1a

| Concentrate no. | Lactic acid | | Benzyl alcohol | | Na-benzoate | | K-sorbate |
|---|---|---|---|---|---|---|---|
| 1 (S-ID 003) | 10 | (47.6 wt. %) | 10 | (47.6 wt. %) | 1 | (4.8 wt. %) | — |
| 2 (S-ID 004) | 10 | (80 wt. %) | 1.5 | (12 wt. %) | 1 | (8 wt. %) | — |

| | | | | | | | |
|---|---|---|---|---|---|---|---|
| 3 (S-ID 006) | 10 | (50 wt. %) | 9.5 | (47.5 wt. %) | — | 0.5 | (2.5 wt. %) |
| 4 (S-ID 007) | 10 | (50 wt.) | 9 | (45 wt. %) | — | 1 | (5 wt. %) |

* Weight percentages are based on the total weight of the resulting concentrate.

The concentrates obtained were substantially free of solvent. However, if so desired, the lactic acid can be added in a form that e.g. contains some water, as a result of which the concentrates would contain small amounts of solvent.

### Example 1a: Preparation of Concentrates

Benzyl alcohol was added to lactic acid (PURAC® HS100), after which a benzoate salt (Na or K) or a sorbate salt (Na or K) was added to form a mixture having the weight ratios as defined in Table 1 b. The mixture comprising lactic acid, benzyl alcohol, and a benzoate salt or a sorbate salt was stirred at 80° C. for 2 hours. The concentrate was then allowed to cool to room temperature. The following, clear and homogenous concentrates were obtained:

TABLE 1b

| Concentrate | | Lactic | | Benzyl | | K- | | Na- | K- | Na- |
|---|---|---|---|---|---|---|---|---|---|---|
| no. | | acid | | alcohol | | benzoate | | benzoate | sorbate | sorbate |
| 5 | (S-ID 103) | 47.75 | wt. % | 47.75 | wt. % | 4.5 | wt. % | — | — | — |
| 6 | (S-ID 101) | 47.75 | wt. % | 42.25 | wt. % | 10 | wt. % | — | — | — |

| | | | | | | | | | |
|---|---|---|---|---|---|---|---|---|---|
| 7 | (S-ID 102) | 47.75 | wt. % | 42.25 | wt. % | — | 10 wt. % | — | — |
| 8 | (S-ID 109) | 47.75 | wt. % | 32.25 | wt. % | — | 20 wt. % | — | — |
| 9 | (S-ID 106) | 50 | wt. % | 45 | wt. % | — | — | 5 wt. % | — |
| 10 | (S-ID 104) | 50 | wt. % | 47 | wt. % | — | — | — | 3 wt. % |
| 11 | (S-ID 105) | 50 | wt. % | 45 | wt. % | — | — | — | 5 wt. % |

* Weight percentages are based on the total weight of the resulting concentrate.

### Example 2: Stability

The stability of the concentrates was assessed by storing a 50 mL sample of each of concentrates 1 to 4 (as obtained in Example 1) in a freezer at 4° C. and −25° C. for up to 28 days. The sample was then removed from the freezer and the turbidity of the sample immediately analyzed. The results of this assessment are summarized in Tables 2a and 2b (each “+” indicates that the concentrate passed the stability test; each “−” indicates that the concentrate did not pass the stability test):

TABLE 2a
stability testing at 4° C. for up to 28 days

| Concentrate | t = 0 | t = 7 | t = 14 | t = 21 | t = 28 |
|---|---|---|---|---|---|
| no. | days | days | days | days | days |
| 1 | + | + | + | + | + |
| 2 | + | + | + | + | + |
| 3 | + | + | + | + | + |
| 4 | + | − | − | − | − |

TABLE 2b
stability testing at −25° C. for up to 28 days

| Concentrate | t = 0 | t = 7 | t = 14 | t = 21 | t = 28 |
|---|---|---|---|---|---|
| no. | days | days | days | days | days |
| 1 | + | + | + | + | + |
| 2 | + | + | − | − | − |
| 3 | + | + | + | + | + |
| 4 | + | − | − | − | − |

The sample containing concentrate 1, which comprised a relatively low amount of sodium benzoate (4.8 wt. %), was stable at both 4° C. and −25° C. Concentrate 2, which comprised a higher amount of sodium benzoate (8 wt. %), was stable at 4° C., but lost some of its stability at −25° C., after 14 days.

The sample containing concentrate 3, which comprised potassium sorbate, was stable at low temperatures and could be stored at −25° C. for at least 28 days. In the sample containing concentrate 4 (not according to the invention), precipitation of solids was clearly visible with the naked eye after storage at 4° C. for 7 days or longer, indicating this concentrate was unstable at that temperature.

### Example 2a: Stability

The stability of the concentrates was assessed by storing a 50 mL sample of each of concentrates 5 to 13 (as obtained in Example 1a) at room temperature (22° C.), at 4° C., and at −25° C. for 4 days. The samples were then analyzed for the turbidity of the sample. The results of this assessment are summarized in Table 2c (each “+” indicates that the concentrate passed the stability test; each “−” indicates that the concentrate did not pass the stability test):

TABLE 2c
stability testing at 22° C., 4° C., and −25° C. for 4 days

| Concentrate no. | 22° C. | 4° C. | −25° C. |
|---|---|---|---|
| 5 | + | + | + |
| 6 | + | + | + |
| 7 | + | + | + |
| 8 | + | + | − |
| 9 | + | + | − |
| 10 | + | + | + |
| 11 | + | + | − |

### Example 3: Preparation of Cleaning Compositions

Cleaning compositions were prepared by mixing sodium laureth sulfate (SLES) and alkyl polyglucoside (APG) into water. Concentrate 1 or 3 (see, Example 1) was then added to the mixture to form cleaning compositions having amounts of SLES, alkyl polyglucoside, concentrate, and water as defined in Table 3a (in wt. %, based on the total weight of the cleaning composition):

TABLE 3a
cleaning compositions comprising the concentrate

| Composi- | Amount | Amount | Amount | Amount | Amount |
|---|---|---|---|---|---|
| tion | of concen- | of concen- | of | of | of |
| no. | trate 1 | trate 3 | SLES | APG | water |
| 1 | 1.0 wt. % | — | 4.0 wt. % | 2.0 wt. % | 93.0 wt. % |
| | 1.1 wt. % | — | 4.0 wt. % | 2.0 wt. % | 92.9 wt. % |
| | 1.5 wt. % | — | 4.0 wt. % | 2.0 wt. % | 92.5 wt. % |
| | 2.0 wt. % | — | 4.0 wt. % | 2.0 wt. % | 92.0 wt. % |
| 3 | — | 1.0 wt. % | 4.0 wt. % | 2.0 wt. % | 93.0 wt. % |
| | — | 1.5 wt. % | 4.0 wt. % | 2.0 wt. % | 92.5 wt. % |
| | — | 2.0 wt. % | 4.0 wt. % | 2.0 wt. % | 92.0 wt. % |

For reference, two further cleaning compositions were made. Cleaning compositions A and B were made by mixing the SLES, APG, benzyl alcohol, and potassium sorbate or sodium benzoate into water to form compositions A and B (Table 3b):

TABLE 3b
reference cleaning compositions

| | | | Amount of | | Amount | | |
|---|---|---|---|---|---|---|---|
| Composition | Amount of | Amount of | benzyl | Amount of | Na- | Amount of | |
| no. | SLES | APG | alcohol | K-sorbate | benzoate | water | |
| A | 4.0 wt. % | 2.0 wt. % | 0.47 wt. % | 0.03 wt. % | — | 93.5 | wt. % |
| B | 4.0 wt. % | 2.0 wt. % | 0.52 wt. % | — | 0.06 wt. % | 93.42 | wt. % |

### Example 4: Antimicrobial Activity

The antimicrobial activity of compositions 1 to 4, as well as compositions A and B (not according to the invention), was measured according to the Pharmacopeia 5.3.1 challenge test. Specifically, samples of 100 mL, including a blank (comprising 4.0 wt. % SLES and 2.0 wt. % APG, but no concentrate), were prepared in triplicate and the samples divided into two samples of 49.5 grams each.

One of the two samples was contaminated with 0.5 mL of a mixture of bacteria (P. aeruginosa (ATCC 15442), S. aureus (ATCC 6538), and E. coli (ATCC 10536)). The CFU/mL of the mixture of bacteria (i.e., the inoculum) was determined by plate count. After a predetermined time (defined in Tables 4a to 4d), 1 mL of the contaminated sample was taken and placed in a standard neutralizer for 5 minutes. Then, in duplo, 1 mL of the neutralized sample was transferred to a Petri dish with a pipette. On top of the neutralized sample, 20 mL of tryptone soy agar (TSA) was poured. The resulting Petri dishes were stored at 37° C. for 24 hours. The CFU/mL was then determined and the log reduction in the number of viable bacteria (as compared to the inoculum) calculated.

TABLE 4a
antimicrobial activity against bacteria at pH 4.5

| Composition | Amount of | | | | |
|---|---|---|---|---|---|
| no. | concentrate | t = 24 h | t = 48 h | t = 7 d | t = 14 d |
| Blank | — | 5.2* | 5.2* | 5.2* | 5.2* |
| 1 | 1.1 wt. % | 5.3* | 5.3* | 5.3* | 5.3* |
| 3 | 1.0 wt. % | 5.3* | 5.3* | 5.3* | 5.3* |

*total kill of bacteria.

TABLE 4b
antimicrobial activity against bacteria at pH 5.5

| Composition | Amount of | | | | |
|---|---|---|---|---|---|
| no. | concentrate | t = 24 h | t = 48 h | t = 7 d | t = 14 d |
| Blank | — | −1.02 | n.d. | −1.3 | −0.8 |
| 1 | 1.1 wt. % | 2.4 | 5.3* | 5.3* | 5.3* |
| | 1.5 wt. % | 2.8 | 5.3* | 5.3* | 5.3* |
| 3 | 1.0 wt. % | 1.9 | 5.3* | 5.3* | 5.3* |
| | 1.5 wt. % | 2.1 | 5.3* | 5.3* | 5.3* |

n.d., not determined:
*total kill of bacteria.

TABLE 4c
antimicrobial activity against bacteria at pH 6.5

| Composition | Amount of | | | | |
|---|---|---|---|---|---|
| no. | concentrate | t = 24 h | t = 48 h | t = 7 d | t = 14 d |
| Blank | — | −1.0 | −0.6 | −1.3 | −0.8 |
| 1 | 1.1 wt. % | 3.0 | 2.7 | 5.1* | 5.1* |
| | 1.5 wt. % | 2.6 | 5.1* | 5.1* | 5.1* |
| 3 | 1.0 wt. % | 1.5 | 2.7 | 5.1* | 5.1* |
| | 1.5 wt. % | 2.0 | 5.1* | 5.1* | 5.1* |
| A | — | n.d. | 5.1* | 5.1* | 5.1* |
| B | — | n.d. | 5.1* | 5.1* | 5.1* |

*total kill of bacteria.

TABLE 4d
antimicrobial activity against bacteria at pH 7.0

| Composition | Amount of | | | | |
|---|---|---|---|---|---|
| no. | concentrate | t = 24 h | t = 48 h | t = 7 d | t = 14 d |
| Blank | — | −1.0 | −0.6 | −1.3 | −0.8 |
| 1 | 1.1 wt. % | 2.0 | 2.4 | 4.3 | 5.1* |
| | 1.5 wt. % | 2.2 | 4.6 | 5.1* | 5.1* |
| 3 | 1.0 wt. % | 1.0 | 2.2 | 4.2 | 5.1* |
| | 1.5 wt. % | 1.2 | 4.4 | 5.1* | 5.1* |

*total kill of bacteria.

TABLE 4e
antimicrobial activity against bacteria at pH 8.0

| Composition | Amount of | | | | |
|---|---|---|---|---|---|
| no. | concentrate | t = 24 h | t = 48 h | t = 7 d | t = 14 d |
| Blank | — | 0.3 | 1.4 | 1.9 | 2.1 |
| 1 | 1.0 wt. % | 0.4 | 0.8 | 5.4* | 5.4* |
| | 1.5 wt. % | 1.2 | 3.0 | 3.9 | 5.4* |
| | 2.0 wt. % | 2.4 | 5.4* | 5.4* | 5.4* |
| 3 | 1.0 wt. % | 0.7 | 1.7 | 5.4 | 3.8 |
| | 1.5 wt. % | 1.9 | 3.8 | 5.4* | 5.4* |
| | 2.0 wt. % | 2.5 | 3.3 | 5.4* | 5.4* |

*total kill of bacteria.

The results in Tables 4a to 4e clearly show that compositions according to the invention are active against a mixture of gram-positive (S. aureus) and gram-negative bacteria (P. aeruginosa and E. coli) across a range of pH values, including at (near-)neutral pH and at alkaline pH.

The onset of antimicrobial activity at the relatively high pH values is quick. Preservative effects can be observed after 24 hours (and even earlier at low pH values (data not shown)). Desired reductions in bacterial population (i.e., log 3 or greater) were observed after contacting for about 48 hours. The antimicrobial activity was also observed after 28 days, even at pH 8.0 (data not shown).

A total kill of bacteria at near-neutral pH could be observed after 7 days for all compositions according to the invention. In contrast, the blank still contained viable bacteria. The time to total kill at near-neutral pH could significantly be reduced (to 48 hours) by slightly increasing the amount of concentrate used (to 1.5 wt. %).

A total kill of bacteria at neutral pH could be achieved with concentrates comprising at least 1.5 wt. % of the concentrate according to the invention. Although no total kill was observed when only 1.1 wt. % of the concentrate was used, the compositions comprising 1.1 wt. % of concentrate still showed significant reductions in bacterial population after 7 days.

The other of the two samples was contaminated with 0.5 mL of a mixture of fungi (C. albicans (ATCC 10231) and A. brasiliensis (ATCC 16414)). The CFU/mL of the mixture of fungi was determined by plate count. After a predetermined time (defined in Tables 5a to 5d), 1 mL of the contaminated sample was taken and placed in a standard neutralizer for 5 minutes. Then, in duplo, 1 mL of the neutralized sample was transferred to a Petri dish with a pipette. On top of the neutralized sample, 20 mL of TSA was poured. The resulting Petri dishes were stored at 37° C. for 24 hours. The CFU/mL was then determined and the log reduction in the number of viable fungi (as compared to the inoculum) calculated.

TABLE 5a
antimicrobial activity against fungi at pH 4.5

| Composition | Amount of | | | | |
|---|---|---|---|---|---|
| no. | concentrate | t = 24 h | t = 48 h | t = 7 d | t = 14 d |
| Blank | — | 0.4 | 1.0 | 0.5 | 1.2 |
| 1 | 1.1 wt. % | 1.0 | 2.1 | 4.7* | 4.7* |
| 3 | 1.0 wt. % | 0.9 | 1.2 | 4.7* | 4.7* |

*total kill of fungi.

TABLE 5b
antimicrobial activity against fungi at pH 5.5

| Composition | Amount of | | | | |
|---|---|---|---|---|---|
| no. | concentrate | t = 24 h | t = 48 h | t = 7 d | t = 14 d |
| Blank | — | 0.3 | 0.5 | 0.6 | 1.0 |
| 1 | 1.1 wt. % | 0.7 | 1.1 | 2.7 | 3.0 |
| | 1.5 wt. % | 1.2 | 2.5 | 4.7* | 4.7* |
| 3 | 1.0 wt. % | 0.4 | 0.7 | 2.5 | 3.3 |
| | 1.5 wt. % | 0.9 | 1.3 | 4.7* | 4.7* |

*total kill of fungi.

TABLE 5c
antimicrobial activity against fungi at pH 6.5

| Composition | Amount of | | | | |
|---|---|---|---|---|---|
| no. | concentrate | t = 24 h | t = 48 h | t = 7 d | t = 14 d |
| Blank | — | 0.5 | 0.5 | 0.6 | 1.1 |
| 1 | 1.1 wt. % | 1.3 | 2.3 | 3.4 | 4.8* |
| | 1.5 wt. % | 2.5 | 3.5 | 4.8* | 4.8* |
| 3 | 1.0 wt. % | 0.9 | 1.5 | 3.1 | 4.8* |
| | 1.5 wt. % | 1.6 | 2.2 | 4.8* | 4.8* |
| A | — | n.d. | 0.6 | 0.6 | 1.6 |
| B | — | n.d. | 0.4 | 0.6 | 1.4 |

n.d., not determined;
*total kill of fungi.

TABLE 5d
antimicrobial activity against fungi at pH 7.0

| Composi- | Amount of | | | | | |
|---|---|---|---|---|---|---|
| tion no. | concentrate | t = 24 h | t = 48 h | t = 7 d | t = 14 d | t = 21 |
| Blank | — | 0.5 | 0.5 | 0.6 | 1.1 | 1.2 |
| 1 | 1.1 wt. % | 0.8 | 1.6 | 2.4 | 3.1 | 4.8* |
| | 1.5 wt. % | 2.3 | 2.9 | 4.0 | 4.8* | 4.8* |
| 3 | 1.0 wt. % | 0.6 | 1.4 | 2.0 | 3.0 | 4.8* |
| | 1.5 wt. % | 1.0 | 2.0 | 3.1 | 4.8* | 4.8* |

TABLE 5e
antimicrobial activity against fungi at pH 8.0

| Composition | Amount of | | | | |
|---|---|---|---|---|---|
| no. | concentrate | t = 24 h | t = 48 h | t = 7 d | t = 14 d |
| Blank | — | −0.1 | 0.1 | 0.1 | 0.1 |
| 1 | 1.0 wt. % | 0.8 | 1.3 | 2.9 | 4.5* |
| | 1.5 wt. % | 1.1 | 1.3 | 4.5* | 4.5* |
| | 2.0 wt. % | 1.0 | 1.5 | 4.5* | 4.5* |
| 3 | 1.0 wt. % | 0.7 | 1.5 | 2.1 | 4.5* |
| | 1.5 wt. % | 1.2 | 1.9 | 2.6 | 4.5* |
| | 2.0 wt. % | 1.1 | 1.6 | 4.5* | 4.5* |

*total kill of bacteria.

The results in Tables 5a to 5e demonstrate that compositions according to the invention are also active against a mixture of fungi (C. albicans and A. brasiliensis) across a broad range of pH values, including (near-)neutral pH. Preservative effects can, at most pH values, be observed as early as after 24 hours of contacting and, in any case, after 48 hours of contacting. Desired reductions in bacterial population (i.e., log 2 or greater) could be observed after 24 hours, but were more common after about 48 hours.

A total kill of fungi could be observed after contacting for 28 days with any composition according to the invention, at any concentration and at any pH tested (data not shown). In contrast, the blank still contained viable fungi. The time to total kill at (near-)neutral pH could significantly be reduced (to 7 days for near-neutral pH and to 14 days for neutral pH) by slightly increasing the amount of concentrate used (to 1.5%).

It should be noted that compositions A and B, which did not contain lactic acid, were inactive against the mixture of fungi. From these results, it can be derived that the specific combination of lactic acid, benzyl alcohol, and the benzoate salt and/or the sorbate salt is required for broad antimicrobial activity at a (near-)neutral high pH.

### Example 5: Robustness and Stability of the Composition Against Recontamination

Products requiring preservation should also be stable against recontamination. Preserving agents are generally able to preserve products that have been sealed (e.g., unopened skin care products), but do not always stabilize the product comprising them against recontamination.

Therefore, the present inventors set out to investigate whether or not the compositions according to the invention are stable to recontamination with bacteria and fungi. After completion of two contamination cycles at pH 6.0 using composition nos. 1 and 3, a third contamination cycle was performed. The antimicrobial effects observed during this third contamination cycle is shown in the Tables below.

TABLE 6a
antimicrobial activity against bacteria at
pH 6.0 during a third contamination cycle

| Composition | Amount of | | | | |
|---|---|---|---|---|---|
| no. | concentrate | t = 24 h | t = 48 h | t = 7 d | t = 28 d |
| Blank | | Growth | Growth | n.d. | Growth |
| 1 | 1.0 wt. % | 1.5 | 3.0 | n.d. | 5.5* |
| | 1.5 wt. % | 3.3 | 5.5* | n.d. | 5.5* |
| 3 | 1.0 wt. % | 2.6 | 5.5* | n.d. | 5.5* |
| | 1.5 wt. % | 3.3 | 5.5* | n.d. | 5.5* |

n.d., not determined;
*total kill of fungi.

TABLE 6b
antimicrobial activity against fungi at
pH 6.0 during a third contamination cycle

| Composition | Amount of | | | | |
|---|---|---|---|---|---|
| no. | concentrate | t = 24 h | t = 48 h | t = 7 d | t = 28 d |
| Blank | — | Growth | Growth | Growth | Growth |
| 1 | 1.0 wt. % | 0.6 | 1.7 | 2.0 | 3.1 |
| | 1.5 wt. % | 1.3 | 3.1 | 4.6* | 4.6* |
| 3 | 1.0 wt. % | 0.2 | 0.5 | 2.6 | 4.6* |
| | 1.5 wt. % | 0.5 | 1.5 | 4.6* | 4.6* |

*total kill of fungi.

As can be derived from Tables 6a and 6b, antimicrobial activity of the compositions against bacteria and fungi was observed even after three consecutive contaminations with bacteria and fungi. The compositions are, thus, surprisingly robust.

### Example 6: Method of Cleaning Using the Cleaning Composition

To assess the efficacy of a cleaning composition according to the invention, a cleaning composition comprising 1.1 wt. % of concentrate 1, 4.0 wt. % SLES, and 2.0 wt. % APG was added to a wipe. The wipe was then used to clean a surface. Desirable cleaning results were observed, without formation of streaks. It is expected that, following cleaning, microbial growth on the cleaned surface was at least temporarily prevented.

1. Concentrate comprising: at least 45 wt. % of lactic acid; from 0.01 to 50 wt. % of benzyl alcohol; from 0.01 to 4.0 wt. % of at least one sorbate salt selected from the group consisting of potassium sorbate and sodium sorbate and/or from 0.01 to 20 wt. % of at least one benzoate salt selected from the group consisting of sodium benzoate and potassium benzoate; and at most 20 wt. % of a solvent.

2. The concentrate according to claim 1, wherein
the weight ratio of lactic acid to benzyl alcohol is in the range of from 0.5:1 to 5:1, preferably from 0.8:1 to 3:1, more preferably from 0.9:1 to 1.5:1, even more preferably about 1:1;
the weight ratio of lactic acid to benzoate salt is in the range from 5:1 to 20:1, preferably from 8:1 to 15:1, more preferably from 9:1 to 11:1, even more preferably about 10:1; and/or
the weight ratio of benzyl alcohol to benzoate salt is in the range of from 2:1 to 20:1, preferably from 5:1 to 15:1, more preferably from 8:1 to 12:1, more preferably from 9:1 to 11:1, still more preferably about 10:1.

3. The concentrate according to claim 1, wherein
the weight ratio of lactic acid to benzyl alcohol is in the range of from 0.5:1 to 5:1, preferably from 0.8:1 to 3:1, more preferably from 0.9:1 to less than 1.1:1;
the weight ratio of lactic acid to sorbate salt is in the range from 11:1 to 25:1, preferably from 17:1 to 23:1, more preferably from 19:1 to 21:1, still more preferably about 20:1; and/or
the weight ratio of benzyl alcohol to sorbate salt is in the range of from 10:1 to 25:1, preferably from 15:1 to 23:1, more preferably from 17:1 to 22:1, even more preferably from 18:1 to 20:1, still more preferably about 19:1.

4. The concentrate according to any one of claims 1 to 3, wherein the concentrate comprises
from 45 to 90 wt. % of lactic acid, preferably from 47 to 85 wt. %;
from 5.0 to 50 wt. % of benzyl alcohol, preferably from 10 to 49 wt. %, more preferably from 30 to 48 wt. %;
from 0.1 to 3.5 wt. % of sorbate salt, preferably from 1.0 to 3.0 wt. %; and/or
from 1.0 to 15 wt. % of benzoate salt, preferably from 2.0 to 10 wt. %, more preferably from 3.0 to 7.0 wt. %.

5. The concentrate according to any one of claims 1 to 4, wherein the concentrate comprises at most 10 wt. % of a solvent, optionally at most 5.0 wt. %, optionally at most 2.0 wt. %, optionally at most 1.0 wt. %, optionally wherein the solvent is water.

6. Composition comprising from 0.1 to 5.0 wt. % of the concentrate according to any one of claims 1 to 5 and at least 40 wt. % of water, wherein the composition has a pH of from 2.0 to 8.0, preferably wherein the composition comprises from 0.5 to 3.0 wt. % of the concentrate, more preferably from 1.0 to 2.0 wt. % of the concentrate.

7. Composition comprising: from 0.3 to 1.0 wt. % of lactic acid or a salt thereof; from 0.1 to 0.9 wt. % of benzyl alcohol; from 0.01 to 0.2 wt. % of at least one sorbate salt selected from the group consisting of potassium sorbate and sodium sorbate and/or from 0.01 to 0.2 wt. % of at least one benzoate salt selected from the group consisting of sodium benzoate and potassium benzoate; and at least 40 wt. % of water, wherein the composition has a pH of from 2.0 to 8.0.

8. The composition according to claim 6 or 7, wherein the composition has a pH of from 3.0 to 8.0, more in particular from 4.0 to 8.0, more in particular from 5.0 to 8.0, more in particular from 5.5 to 8.0, more in particular from 5.5 to 7.5, more in particular from 5.5 to 7.0.

9. The composition according to any one of claims 6 to 8, wherein
the weight ratio of lactic acid to benzyl alcohol is in the range of from 0.5:1 to 5:1, preferably from 0.8:1 to 3:1, more preferably from 0.9:1 to 1.5:1, even more preferably about 1:1;
the weight ratio of lactic acid to benzoate salt is in the range from 5:1 to 20:1, preferably from 8:1 to 15:1, more preferably from 9:1 to 11:1, even more preferably about 10:1;
the weight ratio of benzyl alcohol to benzoate salt is in the range of from 2:1 to 20:1, preferably from 5:1 to 15:1, more preferably from 8:1 to 12:1, more preferably from 9:1 to 11:1, still more preferably about 10:1; and
the composition has a pH of from 3.0 to 8.0, more in particular from 4.0 to 8.0, more in particular from 5.0 to 8.0, more in particular from 5.5 to 8.0, more in particular from 5.5 to 7.5, more in particular from 5.5 to 7.0.

10. The composition according to any one of claims 6 to 8, wherein
the weight ratio of lactic acid to benzyl alcohol is in the range of from 0.5:1 to 5:1, preferably from 0.8:1 to 3:1, more preferably from 0.9:1 to less than 1.1:1;
the weight ratio of lactic acid to sorbate salt is in the range from 11:1 to 25:1, preferably from 17:1 to 23:1, more preferably from 19:1 to 21:1, still more preferably about 20:1;
the weight ratio of benzyl alcohol to sorbate salt is in the range of from 10:1 to 25:1, preferably from 15:1 to 23:1, more preferably from 17:1 to 22:1, even more preferably from 18:1 to 20:1, still more preferably about 19:1; and
the composition has a pH of from 3.0 to 8.0, more in particular from 4.0 to 8.0, more in particular from 5.0 to 8.0, more in particular from 5.5 to 8.0, more in particular from 5.5 to 7.5, more in particular from 5.5 to 7.0.

11. The composition according to any one of claims 6 to 10, wherein the composition is capable of achieving a log reduction in the number of viable fungi of at least 2 (as compared to the value obtained for the inoculum) after contacting for 7 days according to the Pharmacopeia 5.1.3 challenge test, wherein the fungi are a mixture of Candida albicans and Aspergillus brasiliensis; and/or
wherein the composition is capable of achieving a log reduction in the number of viable bacteria of at least 3 (as compared to the value obtained for the inoculum) after contacting for 7 days according to the Pharmacopeia 5.1.3 challenge test, wherein the bacteria are a mixture of Pseudomonas aeruginosa, Staphylococcus aureus, and Escherichia coli.

12. The composition according to any one of claims 6 to 11, wherein the composition is a cleaning composition, preferably a (dish)washing composition.

13. Method of manufacturing the concentrate according to any one of claims 1 to 5, wherein the method comprises the steps of: combining lactic acid, benzyl alcohol, and at least one sorbate salt selected from the group consisting of potassium sorbate and sodium sorbate and/or at least one benzoate salt selected from the group consisting of sodium benzoate and potassium benzoate to form a mixture; and heating the mixture to a temperature of from 65 to 95° C. for at least 30 minutes.

14. Method of manufacturing the composition according to any one of claims 6 to 12, wherein the method comprises the steps of: providing a concentrate according to any one of claims 1 to 5; and diluting the concentrate with water, optionally wherein the diluting is performed in two or more stages.

15. Method of cleaning an object, wherein the method comprises the step of providing the cleaning composition according to claim 12 to an object, optionally using a wipe or a spray.

16. Use of the concentrate according to any one of claims 1 to 5 in a method for preserving a product selected from the group consisting of agrochemical products, cleaning products (in particular, detergents, (dish)washing liquids, industrial cleaning compositions, soaps), metal (working) fluids, medicinal products (in particular, home care products), paints, descaling compositions, or cosmetics, optionally wherein the product has a pH in the range of pH 5.5 to 8.0.

17. Use of the composition according to any one of claims 6 to 12 in a non-therapeutic method for reducing a bacterial population, an algae population, and/or a fungal population, preferably a bacterial population or a fungal population.
